(19) United States
(12) Patent Application Publication
(10) Pub. No.: US 2026/0155452 A1
(43) Pub. Date: Jun. 4, 2026

(54) ALL-SOLID-STATE BATTERY

(71) Applicant: SAMSUNG ELECTRO-MECHANICS CO., LTD., Suwon-si, Gyeonggi-do (KR)

(72) Inventors: Kyunglock Kim, Suwon-si, Gyeonggi-do (KR); Han Kim, Suwon-si, Gyeonggi-do (KR)

(73) Assignee: SAMSUNG ELECTRO-MECHANICS CO., LTD., Suwon-si, Gyeonggi-do (KR)

(21) Appl. No.: 18/695,168

(22) PCT Filed: Feb. 28, 2024
(86) PCT No.: PCT/KR2024/002604

§ 371 Date: Mar. 25, 2024

(30) Foreign Application Priority Data
Nov. 9, 2023 (KR) 10-2023-0154106

(51) Int. Cl. H01M 10/0585; H01M 4/66; H01M 10/0525; H01M 50/534

(52) U.S. Cl. CPC H01M 10/0585; H01M 4/663; H01M 10/0525; H01M 50/534

(57) ABSTRACT

An all-solid-state battery includes: a stack including first and second surfaces facing each other in a first direction, third and fourth surfaces facing each other in a second direction and connecting the first and second surfaces, fifth and sixth surfaces facing each other in a third direction and connecting the first and second surfaces, a solid electrolyte layer, and positive and negative electrode layers alternately stacked in the third direction with the solid electrolyte layer interposed therebetween; a first external electrode connected to the positive electrode layer and disposed outside the stack; and a second external electrode connected to the negative electrode layer and disposed outside the stack, wherein the positive electrode layer includes a positive electrode current collector containing graphite; the negative electrode layer includes a negative electrode current collector containing graphite the first external electrode includes silver (Ag); and the second external electrode includes copper (Cu).

### TECHNICAL FIELD

The present disclosure relates to an all-solid-state battery.

### BACKGROUND ART

Recently, there has been a need for high-capacity batteries as portable electronic devices have been required to have small scales and be used for a long period of time. Further, with the proliferation of wearable electronic devices, there has been a need to ensure the safety of the batteries.

Lithium-ion batteries, which are currently commercially available, use electrolytes containing flammable organic solvents, which may cause overheating and fire in the event of a short circuit. Therefore, there has been proposed an all-solid-state battery that uses a solid electrolyte instead of the liquid or gel electrolyte.

Both positive and negative electrode layers of the all-solid-state battery may include graphite as current collectors. External electrodes respectively connected to the positive and negative electrode current collectors may include silver (Ag). However, silver (Ag) is an expensive material and sometimes causes an electrochemical side reaction such as corrosion and degradation.

### DISCLOSURE OF INVENTION

### Technical Problem

The present disclosure attempts to provide an all-solid-state battery capable of preventing an electrochemical side reaction caused by such as an external electrode.

However, the object to be achieved by the embodiments of the present disclosure is not limited to the above-mentioned object but may be variously expanded without departing from the technical spirit of the present disclosure.

### Solution to Problem

An all-solid-state battery according to some embodiments of the present disclosure includes: a stack including first and second surfaces facing each other in a first direction, third and fourth surfaces facing each other in a second direction and connecting the first and second surfaces, fifth and sixth surfaces facing each other in a third direction and connecting the first and second surfaces, a solid electrolyte layer, and positive and negative electrode layers alternately stacked in the third direction with the solid electrolyte layer interposed therebetween; a first external electrode connected to the positive electrode layer and disposed outside the stack; and a second external electrode connected to the negative electrode layer and disposed outside the stack, wherein the positive electrode layer includes a positive electrode current collector comprising graphite, the negative electrode layer includes a negative electrode current collector comprising graphite, the first external electrode includes silver (Ag), and the second external electrode includes copper (Cu).

In addition, the positive electrode current collector may include a first outer surface and a second outer surface facing each other in the third direction, and a positive electrode active material may be disposed on at least one of the first outer surface and the second outer surface.

In addition, the positive electrode active material may be disposed on the first outer surface and the second outer surface.

In addition, the negative electrode current collector may include a first outer surface and a second outer surface facing each other in the third direction, and a negative electrode active material may be disposed on at least one of the first outer surface or the second outer surface.

In addition, the negative electrode active material may be disposed on the first outer surface and the second outer surface.

In addition, the all-solid-state battery may further include a first margin portion disposed between the second surface of the stack and the positive electrode layer.

In addition, the first margin portion may include at least one of a solid electrolyte or an insulating material.

In addition, the solid electrolyte included in the first margin portion may be identical to a solid electrolyte included in the solid electrolyte layer.

In addition, the solid electrolyte included in the first margin portion may be different from a solid electrolyte included in the solid electrolyte layer.

In addition, the all-solid-state battery may further include a second margin portion disposed between the first surface of the stack and the negative electrode layer.

In addition, the second margin portion may include at least one of a solid electrolyte or an insulating material.

In addition, the solid electrolyte included in the second margin portion may be identical to a solid electrolyte included in the solid electrolyte layer.

In addition, the solid electrolyte included in the second margin portion may be different from a solid electrolyte included in the solid electrolyte layer.

### Advantageous Effects of Invention

According to the all-solid-state battery according to some embodiments of the present disclosure, it is possible to prevent an electrochemical side reaction from occurring on the external electrode.

### BRIEF DESCRIPTION OF DRAWINGS

FIG. 1 is a perspective view schematically illustrating an all-solid-state battery according to an embodiment.

FIG. 2 is a perspective view schematically illustrating a stack of the all-solid-state battery in FIG. 1.

FIG. 3 is a cross-sectional view taken along line III-III′ in FIG. 1.

FIG. 4A is a partial cross-sectional view schematically illustrating a positive electrode layer of the all-solid-state battery in FIG. 1.

FIG. 4B is a partial cross-sectional view schematically illustrating a negative electrode layer of the all-solid-state battery in FIG. 1.

FIG. 5A is a graph illustrating a result of measuring impedance of the all-solid-state battery according to the example and an all-solid-state battery according to a comparative example.

FIG. 5B is an enlarged graph of a part of FIG. 5A.

FIG. 6 is a graph illustrating a result of initially charging and discharging the all-solid-state battery according to the example and the all-solid-state battery according to the comparative example.

FIG. 7 is a graph illustrating a change in discharge capacity of the all-solid-state battery according to the example and the all-solid-state battery according to the comparative example.

FIG. 8 is a graph illustrating a change in Coulombic efficiency of the all-solid-state battery according to the example and the all-solid-state battery according to the comparative example.

### MODE FOR THE INVENTION

Hereinafter, embodiments of the present disclosure will be described in detail with reference to the accompanying drawings so that those with ordinary skill in the art to which the present disclosure pertains may easily carry out the embodiments. In the drawings, a part irrelevant to the description will be omitted to clearly describe the present disclosure, and the same or similar constituent elements will be designated by the same reference numerals throughout the specification. Some constituent elements in the accompanying drawings are illustrated in an exaggerated or schematic form or are omitted. A size of each constituent element does not entirely reflect an actual size.

In addition, it should be interpreted that the accompanying drawings are provided only to allow those skilled in the art to easily understand the embodiments disclosed in the present specification, and the technical spirit disclosed in the present specification is not limited by the accompanying drawings, and includes all alterations, equivalents, and alternatives that are included in the spirit and the technical scope of the present disclosure.

The terms including ordinal numbers such as “first,” “second,” and the like may be used to describe various constituent elements, but the constituent elements are not limited by the terms. These terms are used only to distinguish one constituent element from another constituent element.

In addition, when one component such as a layer, a film, an area, or a plate is described as being positioned “above” or “on” another component, one component can be positioned “directly on’ another component, and one component can also be positioned on another component with other components interposed therebetween. On the contrary, when one component is described as being positioned “directly above” another component, there is no component therebetween. In addition, when a component is described as being positioned “above” or “on” a reference part, the component may be positioned “above” or “below” the reference part, and this configuration does not necessarily mean that the component is positioned “above” or “on” the reference part in a direction opposite to gravity.

Throughout the specification, it should be understood the terms “comprises,” “comprising,” “includes,” “including,” “containing,” “has,” “having” or other variations thereof are inclusive and therefore specify the presence of stated features, integers, steps, operations, elements, components, or combinations thereof, but do not preclude the presence or addition of one or more other features, integers, steps, operations, elements, components, or combinations thereof. Therefore, unless explicitly described to the contrary, the word “comprise/include” and variations such as “comprises/includes” or “comprising/including” will be understood to imply the inclusion of stated elements, not the exclusion of any other elements.

In addition, throughout the specification, the phrase “in a plan view” means when an object is viewed from above, and the phrase “in a cross-sectional view” means when a cross section made by vertically cutting an object is viewed from a lateral side.

In addition, throughout the specification, when one constituent element is referred to as being “connected to” another constituent element, one constituent element can be “directly connected to” the other constituent element, and one constituent element can also be “indirectly connected to,” “physically connected to,” or “electrically connected to” the other element with other elements therebetween. Further, the constituent elements are defined as different names according to positions or functions thereof, but the constituent elements may be integrated.

As used herein, the term “substantially” means a small, insignificant amount from absolute or perfect conditions, dimensions, measurements, results, etc., would be expected by one skilled in the art, but which does not significantly affect overall performance and allow for variation. “Substantially” when used for a number or parameter or property that can be expressed as a number means within 10 percent.

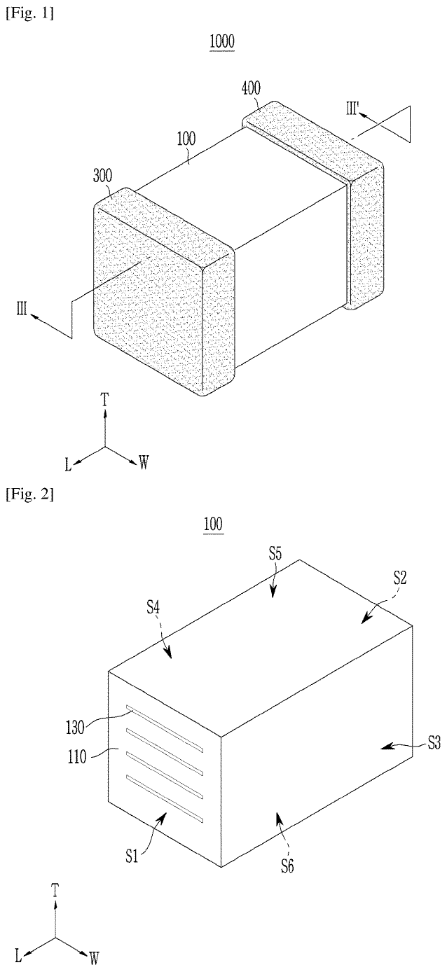

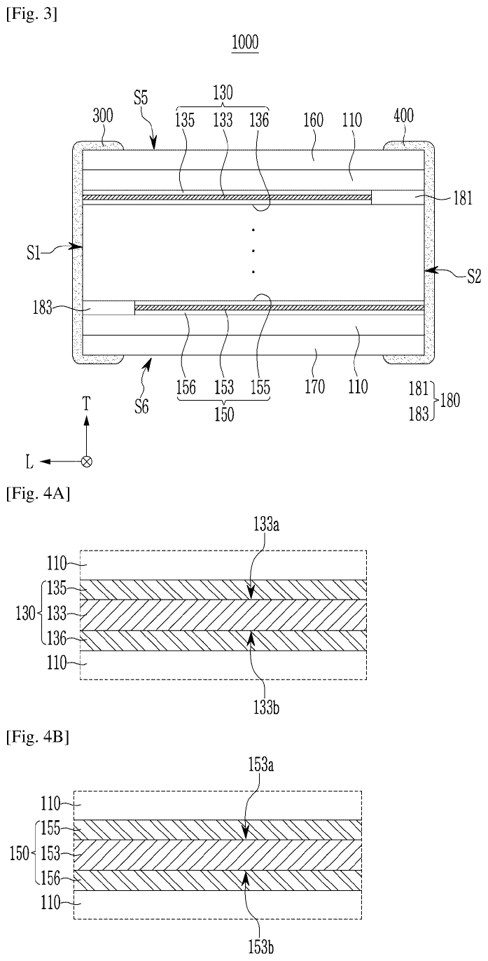

FIG. 1 is a perspective view schematically illustrating an all-solid-state battery according to an embodiment, FIG. 2 is a perspective view schematically illustrating a stack of the all-solid-state battery in FIG. 1, and FIG. 3 is a cross-sectional view taken along line III-III′ in FIG. 1.

With reference to FIGS. 1, 2, and 3, an all-solid-state battery 1000 according to the present embodiment includes a stack 100, a first external electrode 300, and a second external electrode 400.

First, directions are defined in order to clearly explain the present embodiment. An L-axis, a W-axis, and a T-axis illustrated in the drawings respectively indicate axes related to a length direction, a width direction, and a thickness direction of the all-solid-state battery 1000.

The thickness direction (T-axis direction) may be a direction perpendicular to wide surfaces (main surfaces) of constituent elements of the stack 100 having sheet shapes. For example, the thickness direction (T-axis direction) may be used as the same concept as a direction in which the constituent elements of the stack 100 are stacked.

The length direction (L-axis direction) may be a direction parallel to the wide surfaces (main surfaces) of the constituent elements of the stack 100 having sheet shapes, i.e., a direction intersecting (or orthogonal to) the thickness direction (T-axis direction). For example, the length direction (L-axis direction) may be a direction in which the first external electrode 300 and the second external electrode 400 face each other.

The width direction (W-axis direction) may be a direction parallel to the wide surfaces (main surfaces) of the constituent elements of the stack 100 having sheet shapes, i.e., a direction simultaneously intersecting (or orthogonal to) the thickness direction (T-axis direction) and the length direction (L-axis direction).

The stack 100 may have an approximately hexahedral shape. However, the present embodiment is not limited thereto. Due to shrinkage during sintering, the stack 100 may have a substantially hexahedral shape, although not a fully hexahedral shape. For example, the stack 100 has an approximately rectangular parallelepiped shape, but a portion of the stack 100, which corresponds to an edge or vertex, may have a round shape.

In the present embodiment, for convenience of description, surfaces, which face each other in a length direction (L-axis direction), are defined as a first surface S1 and a second surface S2, surfaces, which face each other in a width direction (W-axis direction) and connect the first surface S1 and the second surface S2, are defined as a third surface S3 and a fourth surface S4, and surfaces, which face each other in a thickness direction (T-axis direction) and connect the first surface S1 and the second surface S2, are defined as a fifth surface S5 and a sixth surface S6.

Therefore, a first direction, which is a direction in which the first surface S1 and the second surface S2 face each other, may be the length direction (L-axis direction), and second and third directions, which are perpendicular to the first direction and perpendicular to each other, may be respectively the thickness direction (T-axis direction) and the width direction (W-axis direction) or the width direction (W-axis direction) and the thickness direction (T-axis direction).

Based on an optical microscope or scanning electron microscope (SEM) photograph of a cross-section (taken in the length direction (L-axis direction) and the thickness direction (T-axis direction)) at a central portion of the stack 100 in the width direction (W-axis direction), a length of the stack 100 may mean a maximum value among lengths of a plurality of line segments that connects two outermost boundary lines, which are opposite to each other in the length direction (L-axis direction) of the stack 100 shown in the above-mentioned photograph, and is parallel to the length direction (L-axis direction). Meanwhile, the length of the stack 100 may mean a minimum value among the lengths of the plurality of line segments that connects the two outermost boundary lines, which are opposite to each other in the length direction (L-axis direction) of the stack 100 shown in the above-mentioned photograph, and is parallel to the length direction (L-axis direction). In the meantime, the length of the stack 100 may mean an arithmetic mean value of the lengths of at least two line segments among the plurality of line segments that connects the two outermost boundary lines, which are opposite to each other in the length direction (L-axis direction) of the stack 100 shown in the above-mentioned photograph, and is parallel to the length direction (L-axis direction).

Based on an optical microscope or scanning electron microscope (SEM) photograph of the cross-section (taken in the length direction (L-axis direction) and the thickness direction (T-axis direction)) at a central portion of the stack 100 in the width direction (W-axis direction), a thickness of the stack 100 may mean a maximum value among the lengths of the plurality of line segments that connects two outermost boundary lines, which are opposite to each other in the thickness direction (T-axis direction) of the stack 100 shown in the above-mentioned photograph, and is parallel to the thickness direction (T-axis direction). Meanwhile, the thickness of the stack 100 may mean a minimum value among the lengths of the plurality of line segments that connects the two outermost boundary lines, which are opposite to each other in the thickness direction (T-axis direction) of the stack 100 shown in the above-mentioned photograph, and is parallel to the thickness direction (T-axis direction). In the meantime, the thickness of the stack 100 may mean an arithmetic mean value of the lengths of at least two line segments among the plurality of line segments that connects the two outermost boundary lines, which are opposite to each other in the thickness direction (T-axis direction) of the stack 100 shown in the above-mentioned photograph, and is parallel to the thickness direction (T-axis direction).

Based on an optical microscope or scanning electron microscope (SEM) photograph of a cross-section (taken in the length direction (L-axis direction) and the width direction (W-axis direction)) at a central portion of the stack 100 in the thickness direction (T-axis direction), a width of the stack 100 may mean a maximum value among lengths of a plurality of line segments that connects two outermost boundary lines, which are opposite to each other in the width direction (W-axis direction) of the stack 100 shown in the above-mentioned photograph, and is parallel to the width direction (W-axis direction). Meanwhile, the width of the stack 100 may mean a minimum value among the lengths of the plurality of line segments that connects the two outermost boundary lines, which are opposite to each other in the width direction (W-axis direction) of the stack 100 shown in the above-mentioned photograph, and is parallel to the width direction (W-axis direction). In the meantime, the width of the stack 100 may mean an arithmetic mean value of the lengths of at least two line segments among the plurality of line segments that connects the two outermost boundary lines, which are opposite to each other in the width direction (W-axis direction) of the stack 100 shown in the above-mentioned photograph, and is parallel to the width direction (W-axis direction).

The stack 100 may include a solid electrolyte layer 110, a positive electrode layer 130, a negative electrode layer 150, an upper protective layer 160, a lower protective layer 170, and a margin portion 180.

The stack 100 may include a plurality of the solid electrolyte layer 110, a plurality of the positive electrode layer 130, and a plurality of the negative electrode layer 150. The positive electrode layers 130 and the negative electrode layers 150 may be alternately stacked in the thickness direction (T-axis direction) with the solid electrolyte layers 110 interposed therebetween.

The positive electrode layer 130 may be disposed on one surface of the solid electrolyte layer 110, and the negative electrode layer 150 may be disposed on the other surface of the solid electrolyte layer 110.

The solid electrolyte layer 110 includes a solid electrolyte. The solid electrolyte may serve as a passage for lithium (Li) ions.

The solid electrolyte included in the solid electrolyte layer 110 may include a glass-ceramic-based electrolyte including lithium halide (LiX wherein X is a halogen element such as F, Br, Cl, I, etc.). The glass-ceramic (or a crystallization glass) refers to a crystallographic mixture of amorphous and crystalline materials from which peaks and halos are observed in X-ray diffraction, electron beam diffraction, or the like. Therefore, the glass-ceramic-based electrolyte is an electrolyte that has undergone partial crystallization through sintering and in which amorphous and crystalline materials are mixed.

The glass-ceramic-based electrolyte may be a mixture of an amorphous material and two or more types of crystalline materials. Further, the crystalline materials which are contained in the glass-ceramic-based electrolyte may include a lithium-compound crystalline phase containing lithium.

When the glass-ceramic-based electrolyte is contained in the solid electrolyte layer 110, sufficient densification is achieved after sintering, whereby it is possible to realize high ionic conductivity.

The glass-ceramic-based electrolyte may include at least one selected from the group consisting of lithium (Li) oxide, boron (B) oxide, silicon (Si) oxide, aluminum (Al) oxide, gallium (Ga) oxide, phosphorus (P) oxide, germanium (Ge) oxide, magnesium (Mg) oxide, and lithium chloride (LiCl). As a specific example, the glass-ceramic-based electrolyte may include Li₂O—B₂O₃—SiO₂—P₂O₅—GeO₂—LiCl.

Alternatively, the solid electrolyte contained in the solid electrolyte layer 110 may include a lithium-borosilicate-based electrolyte (hereinafter, also referred to as an LBSO-based electrolyte). The LBSO-based electrolyte is a glass-state electrolyte, and glass refers to a crystallographically amorphous material from which halos are observed in X-ray diffraction, electron beam diffraction, etc.

When the LBSO-based electrolyte is contained in the solid electrolyte layer 110, it is possible to keep the amorphous state during sintering while lowering the sintering temperature. Therefore, there is an advantage that it is possible to realize high ionic conductivity, and reactivity with the electrode is not high. The LBSO-based electrolyte may include lithium (Li), boron (B), silicon (Si), aluminum (Al), phosphorus (P), germanium (Ge), and sulfur (S).

Alternatively, the solid electrolyte contained in the solid electrolyte layer 110 may be one or more types selected from the group consisting of a Garnet-type, a Na super ionic conductor (NASICON)-type, a lithium super ionic conductor (LISICON)-type, a Perovskite-type, and a lithium phosphorus oxynitride (LiPON)-type.

In some embodiments, the solid electrolyte layer 110 may include first and second margin portions 181 and 183. The first and second margin portions 181 and 183, to be described later, may include a material having a low ionic conductivity and electrical conductivity, i.e., an insulating material, or a material having ionic conductivity (or electrical conductivity) similar to the ionic conductivity (or electrical conductivity) of the solid electrolyte. For example, the material having ionic conductivity (or electrical conductivity) similar to the ionic conductivity (or electrical conductivity) of the solid electrolyte included in the first and second margin portions 181 and 183 may be a material identical to or different from the solid electrolyte in other regions. As another example, a material having ionic conductivity (or electrical conductivity) similar to the ionic conductivity (or electrical conductivity) of the solid electrolyte and an insulating material may coexist in the region.

The Garnet-type solid electrolyte may refer to lithium-lanthanum-zirconium-oxide (LLZO) represented by LiₐLa_{b}Zr_{c}O₁₂ such as Li₇La₃Zr₂O₁₂. The NASICON-type solid electrolyte may include lithium-aluminum-titanium-phosphate (LATP) Li₁₊ₓAlₓTi₂₋ₓ(PO₄)₃ (wherein 0<x<1) produced by introducing Ti to Li₁₊ₓAlₓM₂₋ₓ(PO₄)₃(LAMP) (wherein 0<x<2 and M is Zr, Ti, or Ge) type compound, lithium-aluminum-germanium-phosphate (LAGP) represented by Li₁₊ₓAlₓGe₂₋ₓ(PO₄)₃(wherein 0<x<1), such as Li_{1.3}Al_{0.3}Ge_{1.7}(PO₄)₃ containing an excessive amount of lithium, and/or lithium-zirconium-phosphate (LZP) LiZr₂(PO₄)₃.

In addition, the LISICON-type solid electrolyte may include solid solution oxide represented by xLi₃AO₄-(1-x)Li₄BO₄ (wherein A is P, As, V, etc., and B is Si, Ge, Ti, etc.), such as Li₄Zn(GeO₄)₄, Li₁₀GeP₂O₁₂(LGPO), Li_{3.5}Si_{0.5}P_{0.5}O₄, Li_{10.42}Si(Ge)_{1.5}P_{1.5}Cl_{0.08} O_{11.92}, etc., and solid solution sulfide represented by Li₄₋ₓM_{1-y}M′_{y}S₄(wherein M is Si or Ge and M′ is P, Al, Zn, or Ga), such as Li₂S—P₂S₅, Li₂S—SiS₂, Li₂S—SiS₂—P₂S₅, Li₂S—GeS₂, etc.

Further, the Perovskite-type solid electrolyte include to lithium-lanthanum-titanium-oxide (LLTO) represented by Li₃ₓLa_{2/3-x}□_{1/3-2x}TiO₃ (wherein 0<x<0.16, and □ is vacancy), such as Li_{1/8}La_{5/8}TiO₃. The LiPON-type solid electrolyte may refer to nitride such as lithium phosphorous oxynitride such as Li_{2.8}PO_{3.3}N_{0.46-}.

The positive electrode layer 130 may be exposed outside of the stack 100 from the first surface S1 of the stack 100 and connected to the first external electrode 300.

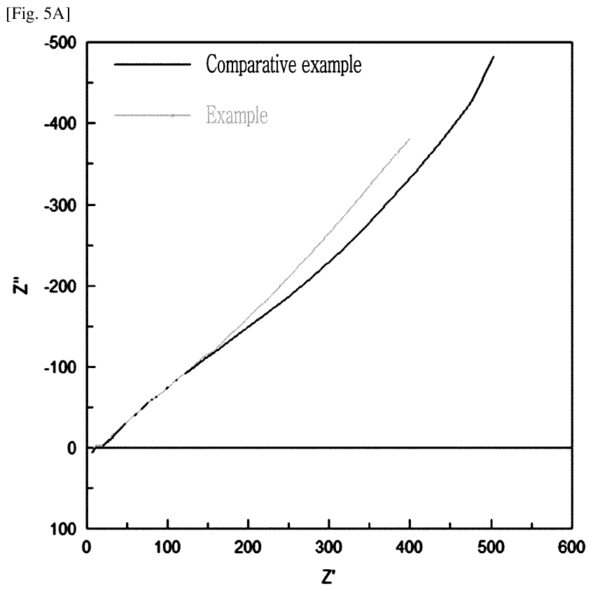

With reference to FIGS. 3 and 4A, the positive electrode layer 130 may include a positive electrode current collector 133, a first positive electrode active material layer 135, and a second positive electrode active material layer 136.

For example, the positive electrode current collector 133 may be made of a plate-shaped member or a thin member. As another example, the positive electrode current collector 133 may be a porous member having a reticulate shape, a mesh shape, or the like.

The positive electrode current collector 133 may include a first surface 133a and a second surface 133b. The first surface 133a and the second surface 133b face each other in the thickness direction (T-axis direction).

For example, the positive electrode current collector 133 may include, but not limited to, a porous metal plate made of, for example, stainless steel, nickel (Ni), copper (Cu), tin (Sn), aluminum (Al), or an alloy thereof.

In addition, the positive electrode current collector 133 may be coated with an oxidation-resistant metal or alloy film to prevent oxidation.

The positive electrode current collector 133 may include a carbon-based plate-shaped, thin, linear, or circular member. The positive electrode current collector 133 may include a conductive carbon material. For example, the conductive carbon material may be graphite, conductive fiber such as carbon nanotube (CNT) or vapor grown carbon fiber (VGCF), or conductive carbon such as carbon black.

Meanwhile, the positive electrode current collector may also include one or more types of solid electrolytes.

The first positive electrode active material layer 135 and the second positive electrode active material layer 136 may include positive electrode active materials and be disposed on a surface of the positive electrode current collector 133. The positive electrode active material layer 135 may be formed by printing a positive electrode active material on one or both surfaces of the positive electrode current collector 133. However, the method of forming the positive electrode active material layer is not limited thereto.

The positive electrode active material in the positive electrode active material layer 135 may comprises a material containing lithium (Li) ions. The positive electrode active material may reversibly intercalate and deintercalate lithium ions. That is, the positive electrode active material may contain lithium ions and serve to provide the lithium ions to the negative electrode when the all-solid-state battery is being charged. The positive electrode active material may affect the capacity and output of the all-solid-state battery.

For example, the positive electrode active material may include at least one selected from the group consisting of compounds represented by the following chemical formulas: LiₐA_{1-b}M_{b}D₂ (wherein 0.90≤a≤1.8, 0≤b≤0.5); LiₐE_{1-b}M_{b}O_{2-c}D_{c} (wherein 0.90≤a≤1.8, 0≤b≤0.5, 0≤c≤0.05); LiE_{2-b}M_{b}O_{4-c}D_{c} (wherein 0≤b≤0.5, 0≤c≤0.05); Liₐ Ni_{1-b-c}Co_{b}M_{c}D_{α} (wherein 0.90≤a≤1.8, 0≤b≤0.5, 0≤c≤0.05, 0<α≤2); LiₐNi_{1-b}Co_{b}M_{c}O_{2α}X_{α} (wherein 0.90≤a≤1.8, 0≤b≤0.5, 0≤c≤0.05, 0<α<2); LiₐNi_{1-b-c}co_{b}m_{c}o_{2-α}X₂ (wherein 0.90≤a≤1.8, 0≤b≤0.5, 0≤c≤0.05, 0<α<2); LiₐNi_{1-b-c}Mn_{b}M_{c}D_{α} (wherein 0.90≤a≤1.8, 0≤b≤0.5, 0≤c≤0.05, 0<α≤2); LiₐNi_{1-b-c}Mn_{b}M_{c}O_{2-α}X_{α} (wherein 0.90≤a≤1.8, 0≤b≤0.5, 0≤c≤0.05, 0<α<2); LiₐNi_{1-b-c}Mn_{b}Mn_{b}O_{2-α}X₂ (wherein 0.90≤a≤1.8, 0≤b≤0.5, 0≤c≤0.05, 0<α<2); LiₐNi_{b}E_{c}G_{d}O₂ (wherein 0.90≤a≤1.8, 0≤b≤0.9, 0≤c≤0.5, 0.001≤d≤0.1); LiₐNi_{b} Co_{c}Mn_{d}GₑO₂ (wherein 0.90≤a≤1.8, 0≤b≤0.9, 0≤c≤0.5, 0≤d≤0.5, 0.001≤e≤0.1); Liₐ NiG_{b}O₂ (wherein 0.90≤a≤1.8, 0.001≤b≤0.1); LiₐCoG_{b}O₂ (wherein 0.90≤a≤1.8, 0.001≤b≤0.1); LiₐMnG_{b}O₂ (wherein 0.90≤a≤1.8, 0.001≤b≤0.1); LiₐMn₂GbO₄ (wherein 0.90≤a≤1.8, 0.001≤b≤0.1); QO₂; QS₂; LiQS₂; V₂O₅; LiV₂O₂; LiRO₂; LiNiVO₄; Li_{(3-f)}J₂ (PO₄)₃(0≤f≤2); Li_{(3-f)}Fe₂(PO₄)₃ (wherein 0≤f≤2); and LiFePO₄. In the above chemical formulas, A is Ni, Co, or Mn; M is Al, Ni, Co, Mn, Cr, Fe, Mg, Sr, V, Nb, Ti, or a rare-earth element; D is O, F, S, or P; E is Co or Mn; X is F, S, or P; G is Al, Cr, Mn, Fe, Mg, La, Ce, Sr, or V; Q is Ti, Mo, or Mn; R is Cr, V, Fe, Sc, or Y; and J is V. Cr, Mn, Co, Ni, or Cu.

In addition, the positive electrode active material may include, but not limited to, LiCoO₂, LiMnₓO₂ₓ (wherein x is 1 or 2), LiNi₁₋ₓMnO₂ₓ (wherein 0<x<1), LiNi_{1-x-y}CoₓMn_{y}O₂(wherein 0≤x≤0.5 and 0≤y≤0.5), LiFePO₄, TiS₂, FeS₂, TiS₃, or FeS₃.

The positive electrode active material may optionally include a conductive material and a binder. However, because an organic material such as a binder decomposes during the sintering process, the organic material may not remain on the positive electrode active material layer of the finally obtained positive electrode current collector.

The conductive material is not particularly limited as long as it has conductivity without causing a chemical change in the all-solid-state battery 1000. For example, graphite such as natural graphite and artificial graphite; carbon-based materials such as carbon black, acetylene black, Ketjenblack®, channel black, furnace black, lamp black, and thermal black; conductive fibers such as carbon fibers, metal fibers, etc.; carbon fluoride; metal components such as lithium (Li), tin (Sn), aluminum (Al), nickel (Ni), copper (Cu), etc., oxides thereof, nitrides thereof, or fluorides thereof; conductive whiskers such as zinc oxide or potassium titanate; conductive metal oxide such as titanium oxide; and conductive materials such as polyphenylene derivatives, etc. may be used.

The binder may be used to improve the bonding forces of the active material, the conductive material, and the like. The binder may include, but not limited to, at least one selected from the group consisting of polyvinylidene fluoride, polyvinyl alcohol, carboxymethylcellulose (CMC), starch, hydroxypropylcellulose, regenerated cellulose, polyvinylpyrrolidone, polytetrafluoroethylene, polyethylene, polypropylene, ethylene-propylene-diene terpolymer (EPDM), sulfonated EPDM, styrene butadiene rubber (SBR), fluoro-rubber, and various copolymers, etc.

Meanwhile, the positive electrode layer 130 may further contain a solid electrolyte component. The solid electrolyte component may contain one or more of the above-mentioned components, and may serve as an ionic conduction channel in the positive electrode layer. Therefore, it is possible to reduce interface resistance.

The negative electrode layer 150 may be exposed outside of the stack 100 from the second surface S2 of the stack 100 and connected to the second external electrode 400.

With reference to FIGS. 3 and 4B, the negative electrode layer 150 may include a negative electrode current collector 153, a first negative electrode active material layer 155, and a second negative electrode active material layer 156.

For example, the negative electrode current collector 153 may be made of a plate-shaped member or a thin member. As another example, the negative electrode current collector 153 may use a porous member having a reticulate shape, a mesh shape, or the like.

The negative electrode current collector 153 may include a first surface 153a and a second surface 153b. The first surface 153a and the second surface 153b face each other in the thickness direction (T-axis direction).

For example, the negative electrode current collector 153 may include, but not limited to, a porous metal plate made of, for example, stainless steel, nickel (Ni), copper (Cu), tin (Sn), aluminum (Al), or an alloy thereof.

In addition, the negative electrode current collector 153 may be coated with an oxidation-resistant metal or alloy film to prevent oxidation.

The negative electrode current collector 153, like the positive electrode current collector 133, may include a conductive carbon-based material, and may include one or more types of solid electrolytes. The negative electrode current collector 153 may be identical to the negative electrode active material layers 155 and 156.

The first negative electrode active material layer 155 and the second negative electrode active material layer 156 may include negative electrode active materials and be disposed on a surface of the negative electrode current collector 153. The negative electrode active material layer 155 may be formed by printing a negative electrode active material on one or both surfaces of the negative electrode current collector 153. However, the method of forming the negative electrode active material layer is not limited thereto.

The negative electrode active material in the negative electrode active material layer 155 may store the lithium ions that have moved from the positive electrode and release the lithium ions when the all-solid-state battery is discharged, thereby generating electrical energy. A carbon-based material, silicon, a silicon oxide, a silicon-based alloy, a silicon-carbon-based material composite, tin, a tin-based alloy, a tin-carbon composite, a metal oxide, or a combination thereof may be used as the negative electrode active material. The negative electrode active material may contain a lithium metal and/or a lithium metal alloy.

The lithium metal alloy may contain lithium, and metal/metalloid capable of making an alloy with lithium. For example, the metal/metalloid capable of making an alloy with lithium may be Si, Sn, Al, Ge, Pb, Bi, Sb, Si-AM alloys (wherein AM is an alkali metal, an alkaline earth metal, an element in group 13 to group 16, a transition metal, a rare-earth element, or a combination thereof, and does not include Si), Sn-AM alloys (wherein AM is an alkaline metal, an alkaline earth metal, an element in group 13 to group 16, a transition metal, a transition metal oxide such as lithium titanium oxide (Li₄Ti₅O₁₂), a rare-earth element, or combinations thereof, and does not include Sn), MnOₓ (wherein 0<x≤2), and the like.

The element AM may be Mg, Ca., Sr. Ba, Ra, Sc, Y, Ti, Zr, Hf, Rf, V. Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or combinations thereof.

In addition, the oxide of the metal/metalloid capable of making an alloy with lithium may include lithium titanium oxide, vanadium oxide, lithium vanadium oxide, SnO₂, SiOₓ (wherein 0<x<2), or the like. For example, the negative electrode active material may contain one or more elements selected from a group consisting of the elements in group 13 to group 16 of the periodic table of elements. For example, the negative electrode active material may contain one or more elements selected from a group consisting of Si, Ge, and Sn.

The carbon-based material may include crystalline carbon, amorphous carbon, or a mixture thereof. The crystalline carbon may be graphite such as natural graphite or artificial graphite that is in a shapeless, disc-shaped, flake-shaped, globular, or fibrous form. In addition, the amorphous carbon may include, but not limited to, soft carbon (low-temperature calcined carbon), hard carbon, mesophase pitch carbide, calcined cokes, graphene, carbon black, fullerene soot, carbon nanotube, carbon fiber, or the like.

The silicon may include at least one selected from the group consisting of Si, SiOₓ (wherein 0<x<2, for example, 0.5 to 1.5), Sn, SnO₂, or silicon-containing metal alloys, and mixtures thereof. For example, the silicon-containing metal alloy may include silicon, and one or more of Al, Sn, Ag, Fe, Bi, Mg, Zn, in, Ge, Pb, or Ti.

The negative electrode active material may optionally include a conductive material and a binder.

The conductive material is not particularly limited as long as it has conductivity without causing a chemical change in the all-solid-state battery 1000. For example, graphite such as natural graphite and artificial graphite; carbon-based materials such as carbon black, acetylene black, Ketjenblack®, channel black, furnace black, lamp black, and thermal black; conductive fibers such as carbon fibers, metal fibers, etc.; carbon fluoride; metal components such as lithium (Li), tin (Sn), aluminum (Al), nickel (Ni), copper (Cu), etc., oxides thereof, nitrides thereof, or fluorides thereof; conductive whiskers such as zinc oxide or potassium titanate; conductive metal oxide such as titanium oxide; or conductive materials such as polyphenylene derivatives, etc. may be used.

The binder may be used to improve the bonding forces of the active material, the conductive material, and the like. The binder may include, but not limited to, at least one selected from the group consisting of polyvinylidene fluoride, polyvinyl alcohol, carboxymethylcellulose (CMC), starch, hydroxypropylcellulose, regenerated cellulose, polyvinylpyrrolidone, polytetrafluoroethylene, polyethylene, polypropylene, ethylene-propylene-diene terpolymer (EPDM), sulfonated EPDM, styrene butadiene rubber (SBR), fluoro-rubber, and various copolymers, etc.

The upper protective layer 160 and the lower protective layer 170 may be outermost layers respectively disposed on the fifth surface S5 and the sixth surface S6 of the stack 100. That is, the upper protective layer 160 may be the outermost layer disposed on the fifth surface S5 of the stack 100, and the lower protective layer 170 may be the outermost layer disposed on the sixth surface S6 of the stack 100. The upper protective layer 160 and the lower protective layer 170 may improve reliability of moisture resistance by preventing moisture penetration and prevent damage caused by physical and chemical stress.

The upper protective layer 160 and the lower protective layer 170 may be insulation layers including an insulating material, i.e., a material that is not electrically (ionically) conductive.

The upper protective layer 160 and the lower protective layer 170 may include, but not limited to, at least one selected from the group consisting of ceramic materials, e.g., alumina (Al₂O₃), aluminum nitride (AlN), beryllium oxide (BeO), boron nitride (BN), silicon (Si), silicon carbide (SiC), silica (SiO₂), silicon nitride (SiN₄), gallium arsenide (GaAs), gallium nitride (GaN), barium titanate (BaTiO₃), zirconium dioxide (ZrO₂), mixtures thereof, oxides thereof and/or nitrides thereof, and any other suitable ceramic material. In addition, the upper protective layer 160 and the lower protective layer 170 may optionally include the above-mentioned solid electrolyte and may include one or more types of solid electrolytes. However, the present disclosure is not limited thereto.

For example, the margin portion 180 may be disposed on the solid electrolyte layer 110 in a region excluding the region where the positive electrode layer 130 or the negative electrode layer 150 is disposed. If the positive electrode layer 130 is disposed on the solid electrolyte layer 110, the margin portion 180 may be disposed in an area excluding the area where the positive electrode layer 130 is disposed. Similarly, if the negative electrode layer 150 is disposed on the solid electrolyte layer 110, the margin portion 180 may be disposed in the region excluding the region where the negative electrode layer 150 is disposed.

With reference to FIG. 3, the margin portion 180 (183) may comprise a portion of the first surface S1 of the stack 100 and the margin portion 180 (181) may comprise a portion of the second surface S2 of the stack 100. Meanwhile, although not illustrated, the margin portion 180 may also comprise a portion of the third surface S3 and a portion of the fourth surface S4 of the stack 100.

The margin portion 180 may be disposed to compensate for a level difference between the solid electrolyte layer 110 and the positive electrode layer 130 and a level difference between the solid electrolyte layer 110 and the negative electrode layer 150. For example, the margin portion 180 may be disposed on the same surface as the positive electrode layer 130 and the negative electrode layer 150. The margin portion 180 may compensate for a level difference between the solid electrolyte layer 110 and the positive electrode layer 130 or a level difference between the solid electrolyte layer 110 and the negative electrode layer 150. Therefore, an increasing the density between the solid electrolyte layer 110 and the electrode layers may prevent interlayer delamination or warping caused by sintering during a process of manufacturing the all-solid-state battery.

The margin portion 180 may be include an insulating material, i.e., a material that is not electrically (ionically) conductive.

The margin portion 180 may include, but not limited to, at least one selected from the group consisting of ceramic materials, e.g., alumina (Al₂O₃), aluminum nitride (AlN), beryllium oxide (BeO), boron nitride (BN), silicon (Si), silicon carbide (SiC), silica (SiO₂), silicon nitride (SiN₄), gallium arsenide (GaAs), gallium nitride (GaN), barium titanate (BaTiO₃), zirconium dioxide (ZrO₂), mixtures thereof, oxides thereof nitrides thereof, and any other suitable ceramic material.

Meanwhile, the margin portion 180 may optionally contain the above-mentioned solid electrolyte, and may include one or more types of solid electrolytes. However, the present disclosure is not limited thereto.

In addition, in the margin portion 180, a material having a low ionic conductivity and electrical conductivity, i.e., an insulating material, may be present, and a material having ionic conductivity (or electrical conductivity) similar to the ionic conductivity (or electrical conductivity) of the solid electrolyte may be present. For example, when a material having ionic conductivity (or electrical conductivity) similar to the ionic conductivity (or electrical conductivity) of the solid electrolyte is present in the margin portion, that material may be a material identical to or different from the solid electrolyte in other regions. As another example, a material having ionic conductivity (or electrical conductivity) similar to the ionic conductivity (or electrical conductivity) of the solid electrolyte and an insulating material may coexist in the margin portion.

The first external electrode 300 and the second external electrode 400 are disposed outside surfaces of the stack 100.

The first external electrode 300 is disposed on the first surface S1 of the stack 100 and connected to the positive electrode layer 130.

For example, the first external electrode 300 may extend to the third surface S3, the fourth surface S4, the fifth surface S5, and the sixth surface S6 of the stack 100 and partially cover the respective surfaces.

The second external electrode 400 is disposed on the second surface S2 of the stack 100 and connected to the negative electrode layer 150.

For example, the second external electrode 400 may extend to the third surface S3, the fourth surface S4, the fifth surface S5, and the sixth surface S6 of the stack 100 and partially cover the respective surfaces.

Meanwhile, in some embodiments, the first external electrode 300 and the second external electrode 400 may extend to one of the fifth surface S₅ and the sixth surface S6 and partially cover the corresponding surface.

The first external electrode 300 may include silver (Ag), and the second external electrode 400 may include copper (Cu).

The positive electrode layer 130 is connected to the first external electrode 300. The positive electrode layer 130 may include the positive electrode active material layers 135 and 136. The positive electrode active material layers 135 and 136 may include a positive electrode material such as a material that contains lithium (Li) ions. In some embodiments, the positive electrode active material may include LiCoO₂ having an electrochemical operating potential (vs. Li/Li+) of 3.0 V or more and 4.5 V or less. The first external electrode may include silver (Ag) having an electrochemical operating potential (vs. Li/Li+) of 2.3 V, which is lower than the electrochemical operating potential of LiCoO₂, such that the first external electrode 300 may be stable.

The negative electrode layer 150 is connected to the second external electrode 400. The negative electrode layer 150 may include the negative electrode active material layers 155 and 156, and the negative electrode active material included in the negative electrode active material layers 155 and 156 may include a carbon-based material (e.g., graphite). For example, the negative electrode active material may include graphite having an electrochemical operating potential (vs. Li/Li+) of 0.5 V or more and 2.5 V or less. The second external electrode may include copper (Cu) having an electrochemical operating potential (vs. Li/Li+) of 400 is 2.7 V, which is higher than the electrochemical operating potential of graphite, such that the second external electrode 400 may be stable.

Unlike the present embodiment, when the second external electrode includes silver (Ag), the electrochemical operating potential (vs. Li/Li+) of silver (Ag) is 2.3 V, which falls within the electrochemical operating potential of graphite, i.e., 0.5 V or more and 2.5 V or less. Therefore, there is a risk of electrochemical side reactions such as corrosion or degradation on the second external electrode.

Meanwhile, the first external electrode 300 and the second external electrode 400 may be fired electrodes that include conductive metal and glass, or may be resin-based electrodes that include conductive metal and resin.

For example, the first external electrode 300 and the second external electrode 400 may be formed by applying a paste for terminal electrodes including conductive metal onto the first surface S1 and the second surface S2 of the stack 100. Alternatively, the first external electrode 300 and the second external electrode 400 may be formed by transferring a dried film, which is made by drying conductive paste, onto the stack 100 and then firing the dried film. However, the method of forming the first external electrode 300 and the second external electrode 400 is not limited thereto. Meanwhile, the conductive metal for the first external electrode 300 may include silver (Ag), and the conductive metal for the second external electrode 400 may include copper (Cu).

Meanwhile, plating layers may be formed on the first external electrode 300 and the second external electrode 400, respectively, thereby improving the mountability of the external electrodes. The plating layer may include, but not limited to, one or more materials selected from a group consisting of copper (Cu), nickel (Ni), tin (Sn), palladium (Pd), platinum (Pt), gold (Au), silver (Ag), tungsten (W), titanium (Ti), lead (Pb), and alloys thereof. The plating layer may comprise one or more layers.

Hereinafter, specific examples of the present disclosure will be described. However, the examples described below are intended only to specifically illustrate and explain the present disclosure, and the scope of the present disclosure should not be limited thereto.

### Manufacturing Example: Manufacturing of all-Solid-State Battery

### Example

On a solid electrolyte layer (green sheet), a plurality of stripe-like positive electrode layers was formed by printing in the order of a positive electrode active material layer, a positive electrode current collector, and a positive electrode active material layer, and then the spaces between the positive electrode layers were filled with insulating materials. In this way, a positive electrode sheet was formed.

On a solid electrolyte layer (green sheet), a plurality of stripe-like negative electrode layers was formed by printing in the order of a negative electrode active material layer, a negative electrode current collector, and a negative electrode active material layer, and then the spaces between the negative electrode layers were filled with insulating materials. In this way, a negative electrode sheet was formed.

The positive electrode sheets and the negative electrode sheets were alternately stacked whereby a green chip was formed.

A stack was formed by cutting the green chip.

The stack was calcined at 400° C. or more and 550° C. or less in an air or nitrogen at-mosphere.

A margin portion was disposed on a surface of the calcined stack.

A conductive paste for a first external electrode, which includes silver (Ag), was applied onto the surface of the stack, a conductive paste for a second external electrode, which includes copper (Cu), was applied onto the surface of the stack, and then the first external electrode and the second external electrode were formed by maintaining the stack in a curing oven sequentially at 50° C., 80° C., and 200° C. for 30 minutes for each temperature and then cooling the stack. In this way, an all-solid-state battery was manufactured.

### Comparative Example

The comparative example was identical to the example, except that a first external electrode and a second external electrode were formed by applying a conductive paste, which includes silver (Ag), onto a surface of a stack.

### Experimental Example: Performance of all-Solid-State Battery

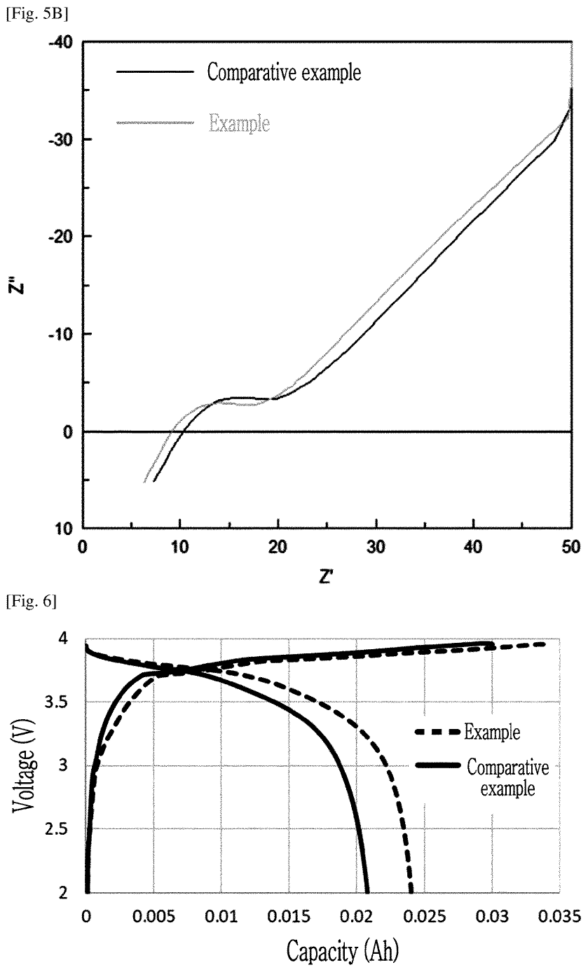

Five all-solid-state batteries according to the example and the comparative example were manufactured, respectively, equivalent series resistance (ESR) of the all-solid-state batteries was measured before a charge/discharge, and then impedance, initial charge/discharge tests, and repeated charge/discharge cycles tests were performed on one representative sample of the example and one representative sample of the comparative example. The results are shown in Table 1 and FIGS. 5A, 5B, 6, 7, and 8.

TABLE 1

| | Sample Number | | | | | | Standard |
|---|---|---|---|---|---|---|---|
| | 1 | 2 | 3 | 4 | 5 | Average | deviation |
| Comparative | 23 | 25 | 22 | 21 | 24 | 23 | 1.581 |
| Example | | | | | | | |
| Example | 21 | 24 | 25 | 23 | 20 | 22.6 | 2.074 |

(unit: Ω)

Referring to Table 1, it can be seen that the average value of the equivalent series resistance (ESR) of the all-solid-state battery manufactured according to the example was 22.6Ω, which is smaller than the average value of the equivalent series resistance of the all-solid-state battery manufactured according to the comparative example, i.e., 23Ω.

Referring to FIGS. 5A and 5B, the impedance Z′ of the all-solid-state battery manufactured according to the example was 19.0Ω, and the impedance Z′ of the all-solid-state battery manufactured according to the comparative example was 20.5Ω. That is, the impedance of the all-solid-state battery manufactured according to the example had a smaller value.

Referring to FIG. 6, the discharge capacity of the all-solid-state battery manufactured according to the example was 0.024 Ah, and the discharge capacity of the all-solid-state battery manufactured according to the comparative example was 0.0207 Ah. That is, the discharge capacity of the all-solid-state battery manufactured according to the example was larger. This is because the second external electrode of the all-solid-state battery manufactured according to the example includes copper (Cu) and thus was more stable than that of the comparative example, which includes silver (Ag).

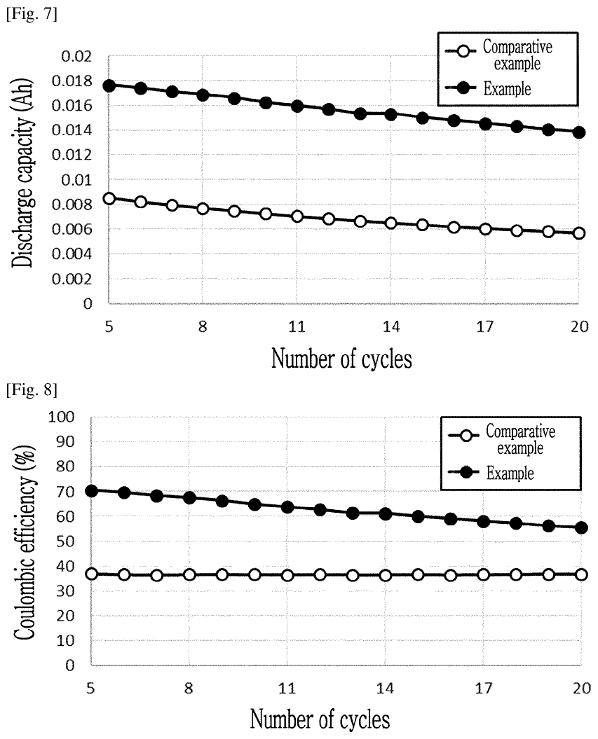

Referring to FIGS. 7 and 8, it can be seen that throughout the total of 20 cycles, the all-solid-state battery manufactured according to the example exhibited better discharge capacity and Coulombic efficiency than the all-solid-state battery manufactured according to the comparative example.

While the embodiments of the present disclosure have been described above, the present disclosure is not limited thereto, and various modifications can be made and carried out within the scope of the claims, the detailed description of the present disclosure, and the accompanying drawings, and also fall within the scope of the present disclosure.

### DESCRIPTION OF SYMBOLS

1000: All-solid-state battery
100: Stack
110: Solid electrolyte layer
130: Positive electrode layer
133: Positive electrode current collector
135, 136: Positive electrode active material layer
150: Negative electrode layer
153: Negative electrode current collector
155, 156: Negative electrode active material layer
160: Upper protective layer
170: Lower protective layer
180, 181, 183: Margin portion
300: First external electrode
400: Second external electrode

1. An all-solid-state battery comprising:
a stack including first and second surfaces facing each other in a first direction, third and fourth surfaces facing each other in a second direction and connecting the first and second surfaces, fifth and sixth surfaces facing each other in a third direction and connecting the first and second surfaces, a solid electrolyte layer, and positive and negative electrode layers alternately stacked in the third direction with the solid electrolyte layer interposed therebetween;
a first external electrode connected to the positive electrode layer and disposed on at least the first surface of the stack; and
a second external electrode connected to the negative electrode layer and disposed on at least the second surface of the stack,
wherein the positive electrode layer includes a positive electrode current collector including graphite,
wherein the negative electrode layer includes a negative electrode current collector including graphite,
wherein the first external electrode includes silver (Ag), and wherein the second external electrode includes copper (Cu).

2. The all-solid-state battery of claim 1, wherein:
the positive electrode current collector includes a first outer surface and a second outer surface facing each other in the third direction, and
a positive electrode active material is disposed on at least one of the first outer surface or the second outer surface.

3. The all-solid-state battery of claim 2, wherein:
the positive electrode active material is disposed on the first outer surface and the second outer surface.

4. The all-solid-state battery of claim 2, wherein:
the negative electrode current collector includes a first outer surface and a second outer surface facing each other in the third direction, and
a negative electrode active material is disposed on at least one of the first outer surface or the second outer surface.

5. The all-solid-state battery of claim 4, wherein:
the negative electrode active material is disposed on the first outer surface and the second outer surface.

6. The all-solid-state battery of claim 1, further comprising:
a first margin portion disposed between the second surface of the stack and the positive electrode layer.

7. The all-solid-state battery of claim 6, wherein:
the first margin portion includes at least one of a solid electrolyte or an insulating material.

8. The all-solid-state battery of claim 7, wherein:
the solid electrolyte included in the first margin portion is substantially identical to a solid electrolyte included in the solid electrolyte layer.

9. The all-solid-state battery of claim 7, wherein:
the solid electrolyte included in the first margin portion is different from a solid electrolyte included in the solid electrolyte layer.

10. The all-solid-state battery of claim 1, further comprising:
a second margin portion disposed between the first surface of the stack and the negative electrode layer.

11. The all-solid-state battery of claim 10, wherein:
the second margin portion includes at least one of a solid electrolyte or an insulating material.

12. The all-solid-state battery of claim 11, wherein:
the solid electrolyte included in the second margin portion is identical to a solid electrolyte included in the solid electrolyte layer.

13. The all-solid-state battery of claim 11, wherein:
the solid electrolyte included in the second margin portion is different from a solid electrolyte included in the solid electrolyte layer.
